(19) United States
(12) Patent Application Publication
(10) Pub. No.: US 2026/0005934 A1
(43) Pub. Date: Jan. 1, 2026

(54) AUTOMATED DIAGNOSIS AND AUDIT OF TELECOMMUNICATION SERVICE PROVISIONING

(71) Applicant: T-Mobile USA, Inc., Bellevue, WA (US)

(72) Inventor: Henry P. Cyril, Bothell, WA (US)

(21) Appl. No.: 18/755,174

(22) Filed: Jun. 26, 2024

(51) Int. Cl. H04L 41/5009; H04L 41/50

(52) U.S. Cl. CPC H04L 41/5009; H04L 41/5032

(57) ABSTRACT

Errors in network service provisioning are upstream causes to service disruptions interruptions, and failures experienced by a telecommunications network’s subscribers. These challenges are overcome by the disclosed systems for diagnosing and auditing service provisioning errors in telecommunications networks. By addressing discrepancies between Customer Facing Services (CFS) as selected by network subscribers (e.g., voice calling, messaging, roaming, unlimited or limited broadband access) and the current states of network elements in the telecommunications network, the system ensures accurate service delivery. The system performs real-time diagnosis by comparing expected network service configurations, derived from queried subscriber CFS, with the actual network states or configurations through a reverse mapping process. The system's auditing process reduces operational costs and obviates existing techniques of manual inspection.

### BACKGROUND

Telecommunications networks play a crucial role in modern communication by providing a variety of services to customers of different network carriers. These services include, but are not limited to, voice calling, Short Message Service (SMS), mobile hotspot functionality, and roaming capabilities. The ability to offer such diverse services is underpinned by sophisticated network infrastructures and protocols that ensure reliable and efficient communication.

As the demand for seamless connectivity continues to grow, the importance of service reliability becomes paramount. Telecommunications networks must ensure that their services are consistently available and perform at high standards to meet user expectations. This involves rigorous maintenance, regular upgrades, and the implementation of robust protocols to prevent disruptions. The reliability of these services is critical for communications, making it a key focus for network carriers and infrastructure providers alike.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a diagram that illustrates a system for enabling customer-facing network services via provisioning of network service configurations throughout a telecommunications network.

FIGS. 4A-4B depict examples of information relating to defining customer-facing network services and network service configurations within the telecommunications network.

FIGS. 5A-5B are block diagrams that illustrates a system for diagnosing or auditing the provisioning of network service configurations throughout a telecommunications network.

FIG. 6 depicts an example of information queried from the network carrier that describes a set of telecommunications services that a network subscriber expects to receive.

FIG. 7 depicts an example of the current configurations of core network elements within the telecommunications network used to diagnose or audit the provisioning of telecommunications services.

FIG. 8 is a block diagram that depicts the determination of discrepancies between provisioned services and the list of services selected or assigned to a network subscriber.

FIG. 9 is a block diagram that depicts the collection of auxiliary information relating to a possible service disruption or interruption experienced by a network subscriber.

FIG. 10 is a block diagram that depicts a reporting of service provisioning diagnosis information to a network carrier.

FIG. 11 is a flow diagram including operations for diagnosing or auditing the provisioning of network service configurations throughout a telecommunications network.

FIG. 12 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present disclosure provides solutions for diagnosing and auditing errors in service provisioning within a telecommunications network. By addressing discrepancies between customer selections of network services (e.g., a carrier plan) and network configurations/profiles, these solutions enable early and upstream detection of service disruptions, thereby enhancing user experience and reducing operational costs for network operators.

As referred to herein, Customer Facing Services (CFS) are human-defined and human-readable definitions of services provided or enabled via a telecommunications network. Examples of CFSs include the individual services offered in carrier rate plans and add-ons that are selected by customers. For instance, voicemail service may be one individual CFS. A CFS requires certain network attributes and configurations to be implemented across the telecommunications network, and these network attributes and configurations can be individually defined or discretized as Network Facing Services (NFS). The translation of CFS into NFS is a complex process involving multiple systems and network elements (e.g., voicemail as one CFS may require multiple network profiles being configured and provisioned at many network elements). Discrepancies between the NFS that a CFS requires and the actual network configuration can result in customers not receiving the correct services, receiving degraded services, or receiving additional services.

When service issues arise, network carriers often face challenges in diagnosing and resolving these problems due to the lack of visibility into the network facing services within the network elements. Existing system rely on the creation of support tickets that require technical invention and manual investigation of network states. The process of troubleshooting these issues can be time-consuming, leading to delayed resolutions and increased operational costs for the network carrier.

The technical solutions described herein introduce a system that enables real-time diagnosis and auditing of service provisioning errors. This system may be implemented as a core network function or element that is able to probe and query other network elements in the core network, where NFSs may (or may not) be provisioned. The system may perform processes that include determining what CFSs are assigned to a customer, translating the assigned CFSs to corresponding NFSs, and performing a mapping of current network configurations to the corresponding NFSs to identify any incorrectly provisioned CFSs for the customer. A diagnosis reporting any incorrectly provisioned CFSs for the customer can then be provided to the network carrier via which the customer uses the telecommunications network, offering real-time information on correctly and incorrectly provisioned network features. This process can resolve issues promptly and preemptively, thus enhancing the operational efficiency for network operators.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Example Embodiments of Wireless Communications Systems

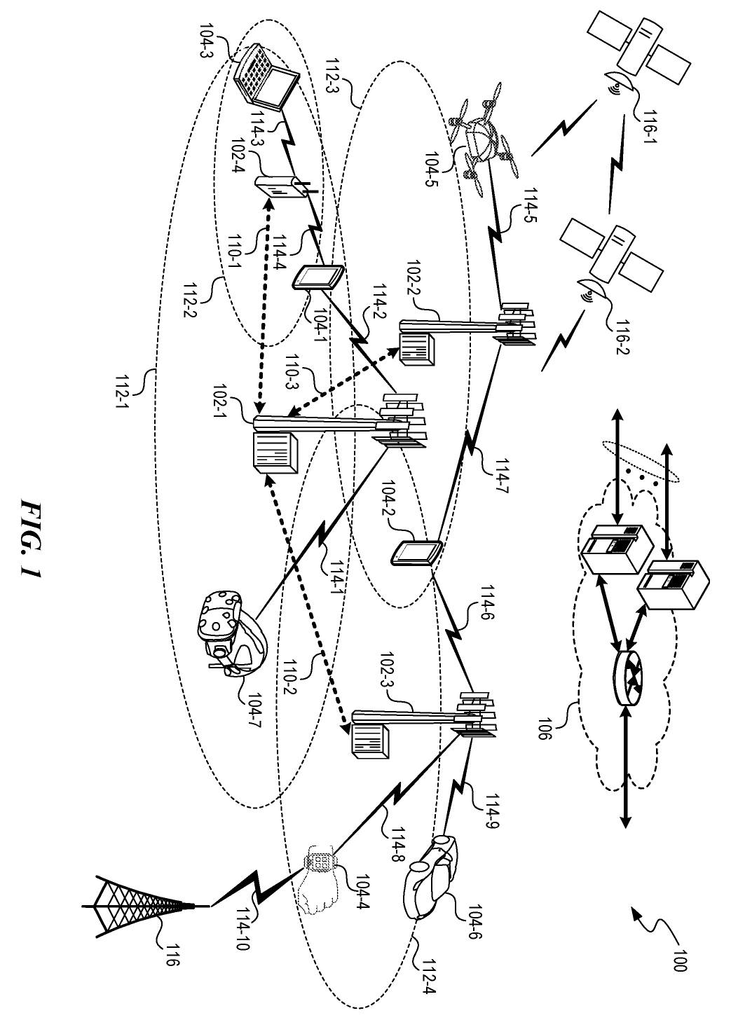

FIG. 1 is a block diagram that illustrates a wireless telecommunication network 100 (“network 100”) in which aspects of the disclosed technology are incorporated. For example, the network 100 is configured to enable RCS communication for its subscribers. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity (e.g., for RCS messaging), and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Example Embodiments of 5G Core Network Functions

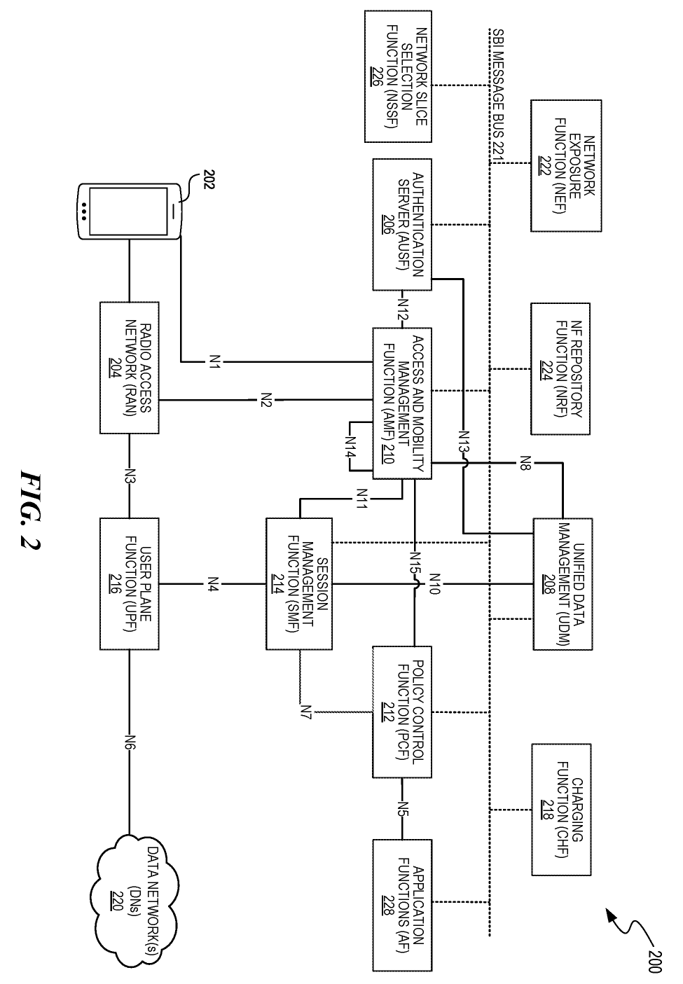

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Example Embodiments for Diagnosing Network Service Provisioning

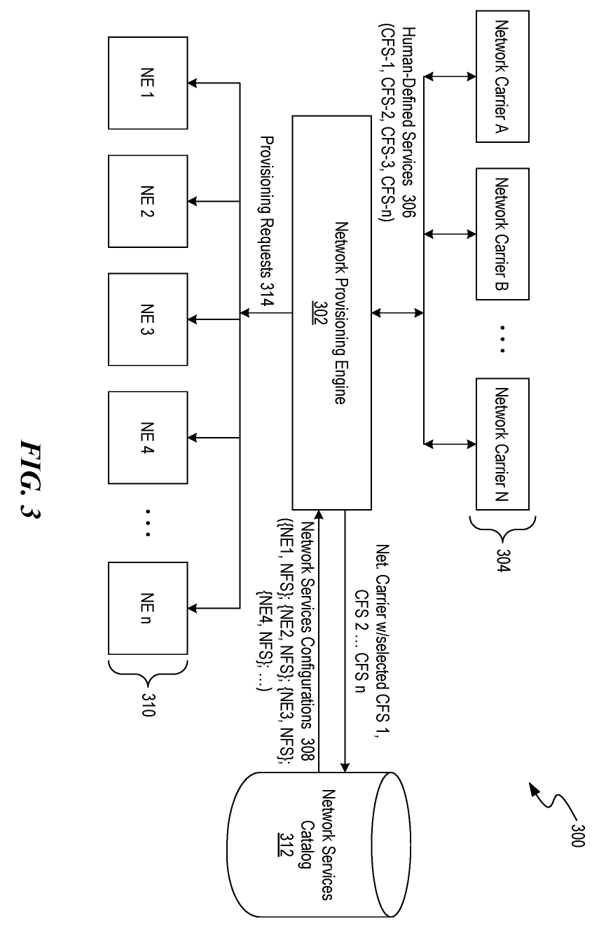

FIG. 3 illustrates an example system in which telecommunication services selected by a network customer are provisioned into the customer’s serving telecommunications network. Provisioning in system 300 is performed via a network provisioning engine 302. In some embodiments, the network provisioning engine 302 is an application function in the telecommunications network’s core.

The network provisioning engine 302 is configured to interface with one or more network carriers 304 for the telecommunications network, such that the network carriers 304 are able to communicate selections or sets of human-defined services 306. The one or more network carriers 304 share the telecommunications network’s infrastructure, services, spectrum license, and/or the like. For instance, the one or more network carriers 304 may include a mobile network operator (MNO) that owns the telecommunication network (e.g., the network infrastructure, the network’s radio spectrum license) and a mobile virtual network operator (MVNO). Further, the network carriers 304 may include multiple different organizations, brands, or carriers under the umbrella of the MNO owning the telecommunications network (and/or of a MVNO associated with the telecommunications network). For instance, for a telecommunications network owned and operated by T-Mobile, there may be two different brands referred to as T-Mobile Pre-Paid and T-Mobile Postpaid that are operated and interface with the network as separate network carriers.

The network provisioning engine 302 receives information from a network carrier 304 describing a set of human-defined services 306 (also understood as customer-facing services, or CFS) that a customer of the network carrier 304 has selected or subscribed to. These human-defined services 306 are services providable by the telecommunications network that are discretized from the perspective of a customer or user. Examples of human-defined services 306 include: 1) Voice; 2) International Voice; 3) Roaming international/Domestic; 4) Call Forwarding; 5) Call waiting capability; 6) Short Message Service (SMS); 7) Multimedia Messaging Service (MMS); 8) Rich Communications Services (RCS); 9) Data – Domestic; 10) Data – Hotspot; 10) Data – Roaming; 11) Voicemail; 12) Static IP management; and the like. Human-defined services 306 are therefore readable, understandable, parse-able, and selectable by a customer when defining the scope of the service it receives from its network carrier 304. Human-defined services 306 may be defined and managed by billing subsystems of the network carrier, as each human-defined service may be an individual subscribed or purchased item for a customer of the network carrier. The billing subsystem of the network carrier may store information identifying which human-defined services 306 are associated with a given customer of the network carrier.

Human-defined services 306 can be contrasted against network service configurations 308, although a human-defined service 306 corresponds to one or more network service configurations 308. Network service configurations 308 that correspond to a human-defined service 306 implement the human-defined service 306 across the necessary network functions or network elements 310 in the telecommunications network. For instance: Domestic Roaming as a human-defined service 306 may require one or more network service configurations 308 to be provisioned in an Access Mobility Function (in a 5G telecommunications network) and/or other network elements to the core network to prepare and execute a handover for a user equipment (UE) authenticated for the customer. Examples of network elements 310 at which network service configurations 308 are provisioned include HLR/HSS (Home Location Register/Home Subscriber Server), CS (Charging System), NAP (Policy Enforcement Server), SMS (Short Message Service Server), VMS (Voice Mail Server), Entitlement Server, GFLEX, AAA (Authentication, Authorization, Accounting), CTUNES (Caller Tunes), VAS, MSTORE, WSG (Web Services Gateway), OTA (Over the Air) System, and/or the like.

Provisioning a network service configuration 308 at a network element 310 may include creating a profile associated with the customer at the network element 310, updating the customer’s profile at the network element 310, deleting and re-creating the customer’s profile at the network element 310, and/or the like. The effect of provisioning the network service configurations 308 associated with a human-defined service 306 within the telecommunications network is the implementation and enabling of the human-defined service 306.

The system 300 includes a network services catalog 312 or a database that stores pre-defined translations between human-defined services 306 and the network service configurations 308 that implement them. The network services catalog 312 may further store information that indicates at which network element 310 a network service configuration 308 should be provisioned. The network provisioning engine 302 can send a query to the network services catalog 312 that includes a set of human-defined services 306 and receive a response from the network services catalog 312 that includes the network service configurations 308 (and the network elements 310 where they should be provisioned) needed to implement each human-defined service 306. In some embodiments, the network provisioning engine 302 can identify, in its query to the network services catalog 312, the network carrier that established the human-defined services 306 with its customer. Human-defined services 306 may be carrier-specific and defined within the network services catalog differently. For instance, a “high-speed broadband” as a human-defined service under a first network carrier may translate to higher bandwidth limits in network service configurations, compared to “high-speed broadband” as a human-defined service under another network carrier. In some embodiments, the catalog may include separate information for each brand, sub-brand, and common services.

Based on receiving this information from the network services catalog 312, the network provisioning engine 302 can begin implementing the human-defined services 306 by provisioning the network service configurations 308 at the target network elements. The network provisioning engine 302 can send provisioning requests 314 to particular ones of the network elements 310 to provision the network service configurations 308.

More specifically, the network service configuration associated with a CFS as informed by the catalog indicates both the network element/node where a provisioning action is performed and the data features that must be edited, instantiated, provisioned, or the like. A network service configuration may include a resource facing specification and a logical resource specification. Each CFS requires one or more network elements to be provisioned where each network element is identified by a resource facing specification (RFS). The feature in each network element is defined by a set of key-value pairs described by logical resource specifications (LRS). Cross-brand catalog information captures the relationship for each rate plan (CFS->RFS->LRS). In the present disclosure, a RFS and a LRS (or a pair thereof) may also be referred to as a network facing specification (NFS), and cross-brand catalog information may be defined as a relationship between a CFS and an NFS. In some embodiments, in order to speed up the CFS-NFS mapping and for NFS-to-CFS mapping, the catalog configuration may be also stored in-memory as cache to speed-up the processes disclosed herein.

Consider an illustrative example including CFSs of VOICE_MO_NAT identifying outgoing call feature within US, CFW identifying call-forwarding feature, and TETH_10GB_CAP identifying tethering up to 10GB data that is capped once that limit is reached. Each CFS is associated (via catalog information) with one or more RFS that identifies the network node whose subscriber profile needs to be updated. For example, in the VOICE_MO_NAT and CFW features, the only RFS may be HLR/HSS whereas the TETH_10GB_CAP feature needs update in HLR/HSS, NAP (Nokia Application Publisher), and CS (Charging System). Each RFS is associated with one or more LRS that identifies the name and value that needs to be set in each network node. For example, for the VOICE_MO_NAT service, the key/name-value pairs that need to be set in the HLR/HSS includes ts11=0 and odboc=4, enabling the user to make outgoing calls. For the TETH_10GB_CAP service, the thresholds identifier that holds the 10GB bucket needs to be set in CS (Charging System) and the capped behavior to enforce needs to be set in NAP (Nokia Application Publisher). The catalog that has the above mappings identifying the various combinations of brand, sub-brand, CFS, RFS, NFS are arranged in a logical in-memory cache layout that can then be updated individually.

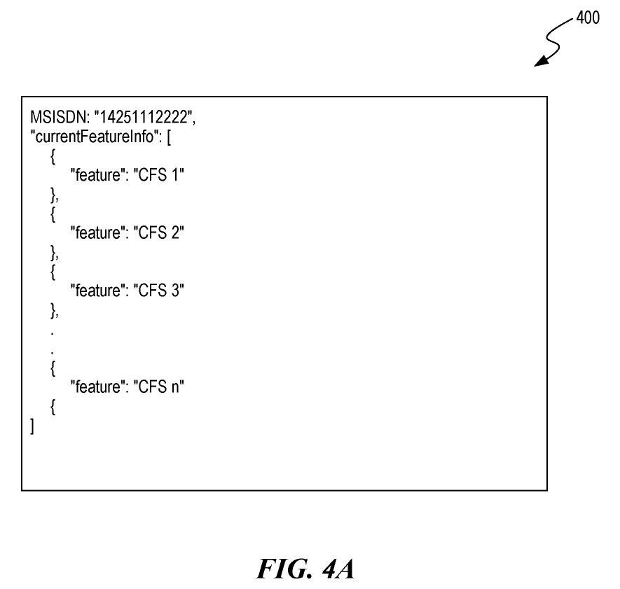

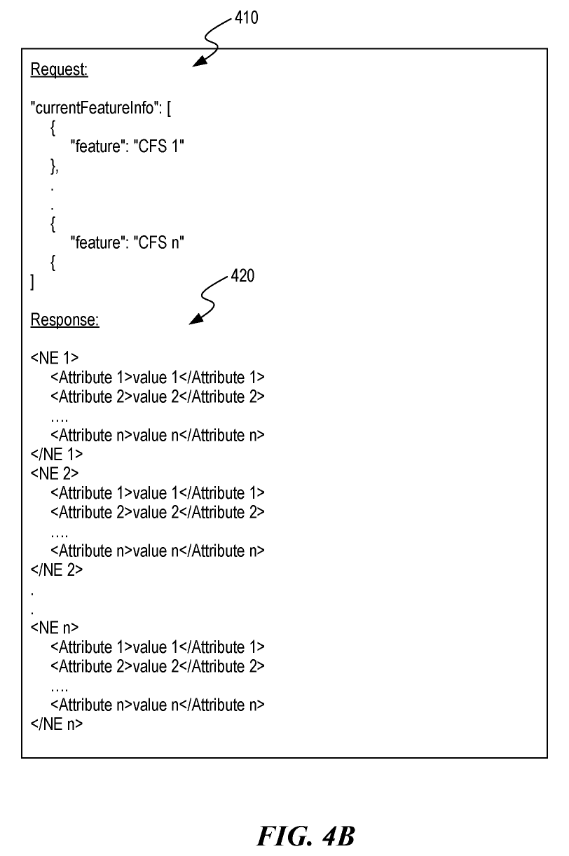

FIGS. 4A and 4B illustrate examples of the human-defined services information and the network service configurations information communicated within the system 300. FIG. 4A illustrates an example of a human-defined services information 400, which includes a set of human-defined services (e.g., “CFS 1”, “CFS 2”). In some embodiments, the human-defined services information 400 further includes an identifier associated with the customer or subscriber, such as a Mobile Station International Subscriber Directory Number (MSISDN). With this customer or subscriber identifier (e.g., an MSISDN), the human-defined services information 400 conveys what particular telecommunication services that a particular customer/subscriber has selected and requires. In some embodiments, this human-defined services information 400 is transmitted by a network carrier 304 to the network provisioning engine 302 in order for the network carrier 304 to enable the telecommunications network to provide the carrier’s customer (e.g., identified via MSISDN) with its selected telecommunications services (e.g., the set of human-defined services).

FIG. 4B illustrates an example of a catalog request 410 sent by the network provisioning engine 302 to the network services catalog 312 and an example of a catalog response 420 sent by the network services catalog 312 to the network provisioning engine 302. As illustrated, the catalog request 410 includes a set of human-defined features to be translated into network service configurations by the network services catalog 312. In some embodiments, an identification of the network carrier (e.g., an MNO/MVNO brand or sub-brand) is included in the catalog request 410 to be used as a primary key to access specific catalog information that translates CFSs to NFSs.

In some embodiments, the catalog response 420 includes a set of network elements at which provisioning actions need to be performed (e.g., “NE 1”, “NE 2”). The catalog response 420 further includes the data (e.g., attribute values) that need to be provisioned at each of the set of network elements. For example, the data includes flag values that enable or disable a function performed by a network element (e.g., enable/disable call routing), threshold values that limit a function performed by a network element, identifier values (e.g., serial values, encryption key values), and/or the like.

As a non-illustrative example: a customer buys a new line with a network carrier. This transaction arrives at the network provisioning engine (from the network carrier’s billing subsystem) as an activation/provision request with a list of the CFSs to provision for the customer’s new line (e.g., voice calling, text messaging, data or mobile broadband, Wi-Fi calling, scam protection, companion device pairing, and/or the like). The network provisioning engine translates these CFSs to network service configurations which include network attributes or network profiles (e.g., around 10,000 attributes to be configured). As the center of the provisioning flow, the network provisioning engine provisions various network elements (e.g., around 15 for some CFSs) for various APIs (e.g., around 20 for some CFSs) for the enablement of each CFS. There may be alternative transactions, some voluntary and some involuntary by customer, besides buying a new line in which a network carrier engages with the network provisioning engine. These include: Activation; Deactivation; Port-In; Port-Out; Update Customer Profile; Update Feature; Suspension; Restore; Change MSISDN; Change subscriber identity module (SIM); Change Bill Cycle; BAN-to-BAN (billing account number) Change; Add/Deduct Balance; Voicemail PIN Reset. Each of these transactions updates a customer’s network profile which updates the services of the customer. These updates to the services of the customers need to be accurately reflected and provisioned in the telecommunications network’s configurations.

Embodiments disclosed herein address technical challenges relating to provisioning network services and diagnosing errors related to service provisioning. The translation of one human-defined service to multiple network service configurations to be provisioned at multiple network elements is complex and prone to errors. Thus, a network customer may expect but fail to receive certain human-defined services from the telecommunications network as a result of errors in provisioning the network service configurations in the network elements. For example, the network provisioning engine may fail to perform a provisioning action with a network element in order to provision a network service configuration. As another example, a network element may be non-responsive to the network provisioning engine attempt to perform a provisioning action therewith. As yet another example, a data corruption at the network element may occur, or the network provisioning engine may provision a network service configuration with incorrect data values.

Thus, if there is a discrepancy between billing products (e.g., human-readable services) and network profiles (e.g., network service configurations) for a customer, the customer will not get the right telecommunications services. Examples of service disruptions or degradations experienced by customers (e.g., as a result of incorrect provisioning) include: customers cellphone not registering to Network; customers voice call not working; customers data service not working; customer’s SMS not working; customer don’t have right coverage; customer don’t have access to voicemail; customer’s mobile number portability not completed; and customer’s short code SMS (important messages from bank etc.) not working.

While a service disruption may have other causes unrelated to service provisioning (e.g., local user equipment hardware faults), service provisioning is a threshold or upstream cause. However, at least from the perspective of network carriers, provisioning errors are difficult to detect and diagnose. These challenges are exacerbated for MVNOs who do not own the infrastructure for the telecommunications network. When a customer reports a service disruption to a network carrier, the customer can only identify the CFS. Some network carriers (e.g., MVNOs) are not equipped to translate the identified CFS to NFSs in order to pinpoint the problem in the network. Other network carriers may not have the tools to check and repair configurations at specific network elements. Thus, resolution may fall all upon an MNO that owns and manages the telecommunications network.

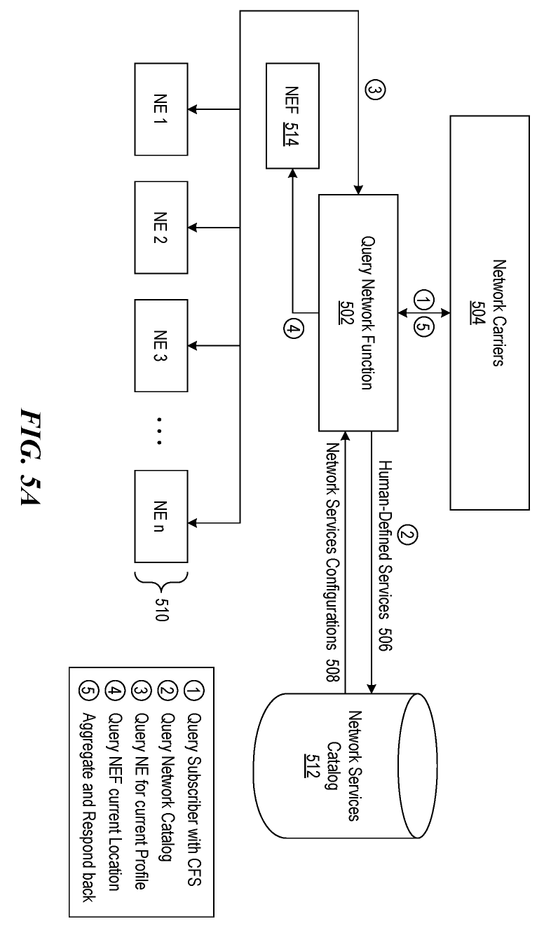

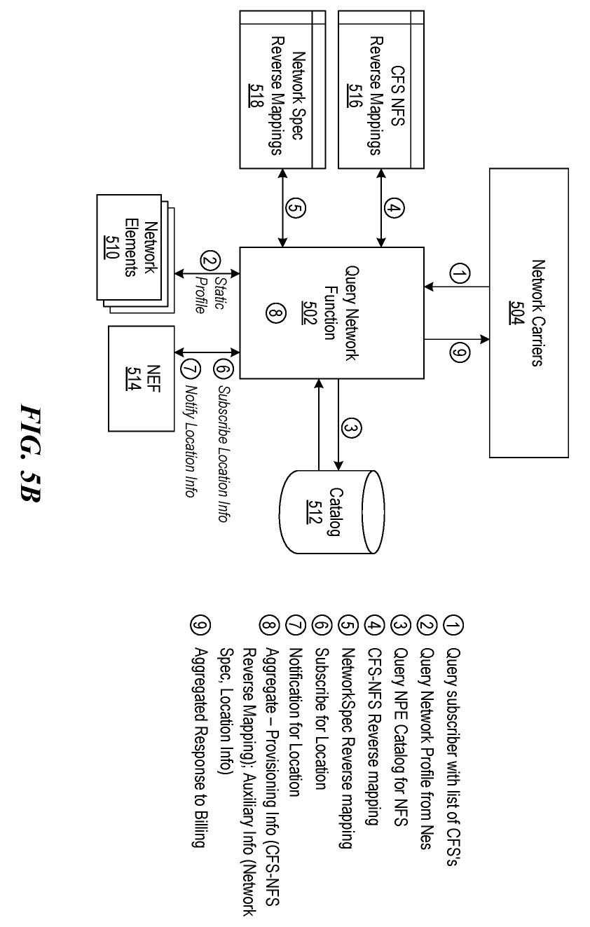

FIGS. 5A-5B illustrates a diagnosis or audit system that provides technical solutions addressing these challenges. The system includes a query network function 502 that implements the techniques disclosed herein to determine whether a customer/subscriber’s list of telecommunications services are properly provisioned. After services are provisioned, the network diagnosis system ensures that the implemented configurations at the core network elements accurately reflect the services that the subscriber has subscribed to.

As depicted in FIG. 5A, the query network function 502 is generally configured to (i) query subscriber with CFS, (ii) query the network services catalog 512, (iii) query network elements 510 for their current profiles, (iv) query the NEF 514 (network exposure function) for a subscriber’s current location, and (v) aggregate the queried information and respond back to the network carriers 504. FIG. 5B additionally depicts that the query network function 502 processes the information it queries for by performing a CFS-NFS reverse mapping 516 and performing a network specification reverse mapping 518.

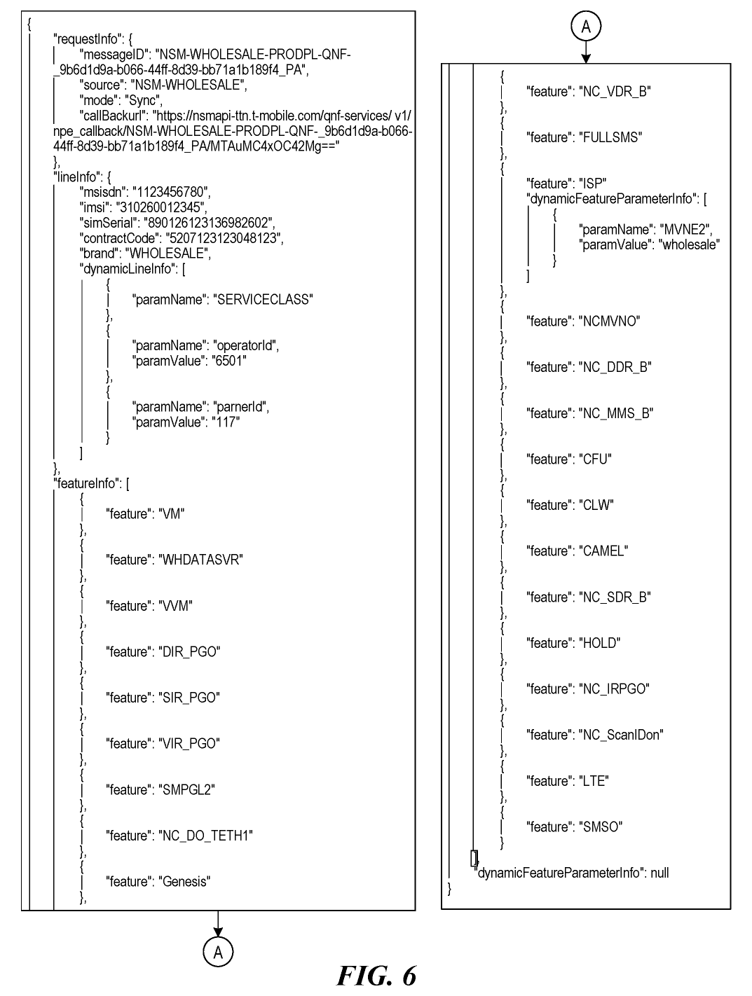

The query network function 502 determines the set of CFSs that are assigned to a network subscriber (action 1 in FIG. 5A; action 1 in FIG. 5B) to begin the process of diagnosing the network provisioning of these CFSs. The query network function 502 may determine the CFSs for the network subscriber based on querying the network carrier 504 (or its billing subsystem) via which the network subscriber uses the telecommunications network. For instance, the query network function 502 may be configured to routinely or periodically audit service provisioning for various subscribers. The network carrier 504 may have previously transmitted a prompt to the query network function 502 that establishes a period or frequency by which the query network function 502 provides an audit report and subsequent reports describing correctly and incorrectly provisioned services. Alternatively, the query network function 502 receives the set of CFSs for a network subscriber in a prompt received from the network carrier 504. For instance, a service disruption may have been reported to the network carrier 504, and the query network function 502 is configured to begin diagnosis of network service provisioning in response to the prompt received from the network carrier 504. FIG. 6 depicts an example of a query sent by the query network function 502 to a network carrier 504 to determine a list of CFSs assigned to a network subscriber.

The query network function 502 also queries the network services catalog 512 to translate the CFSs assigned to a network subscriber (human-defined services 506) into network service configurations 508 (action 2 in FIG. 5A, action 3 in FIG. 5B). The query network function 502 may do so according to the same processes discussed above as performed by the network provisioning engine to provision CFSs in the network.

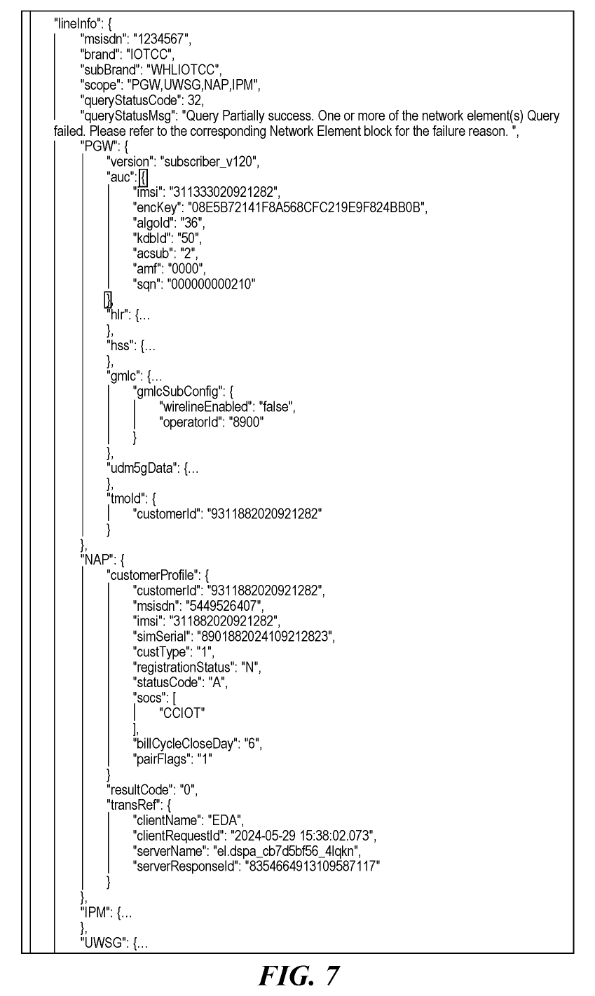

The query network function 502 meanwhile queries the network elements 510 for the current profiles implemented thereat (action 3 in FIG. 5A, action 2 in FIG. 5B). The query network function 502 may do so concurrently, before, or after its query to the network services catalog 512. FIG. 7 depicts an example of current profile/configuration information returned by a network element 510. The data in the illustrated example of FIG. 7 may be generated by the query network function 502 to include an array of multiple network elements with unique structures based on its queries to the multiple network elements.

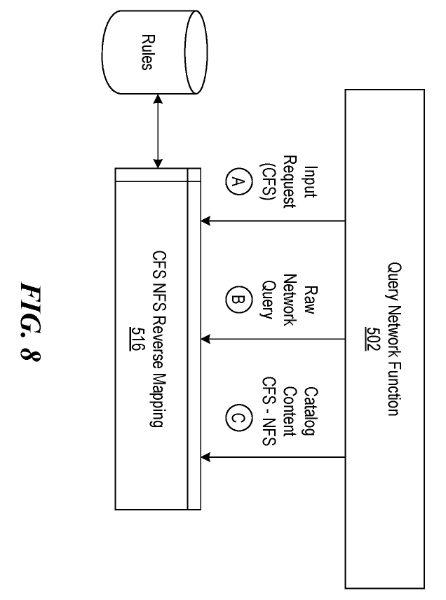

FIG. 8 depicts the CFS-NFS reverse mapping 516 performed by the query network function 502 using the information it queried for. Raw query network information is compared to the catalog’s NFS information. The identified discrepancy is reverse-mapped from (Delta NFS —> CFS) to come-up with 1) missing features 2) additional features 3) misaligned features. The query network function 502 uses the catalog translation content (e.g., network service configurations 508 expected for a human-defined service 506) as a comparison/mapping reference, and with static and dynamic rules (e.g., “If((Carrier_1 && non-IOT) enable VOICE){…}; “If(Prepaid) enable real-time call control;”) validates the current configuration information of the network elements 510 obtained via its raw network query. The rules may specify attributes that can be ignored in the comparison/mapping, such as unique customer identifiers. This comparison or mapping can output matched CFSs, additional services, missing services, and misaligned services. In some embodiments, the CFS-NFS reverse mapping 516 is performed in parallel for each CFS assigned to the customer.

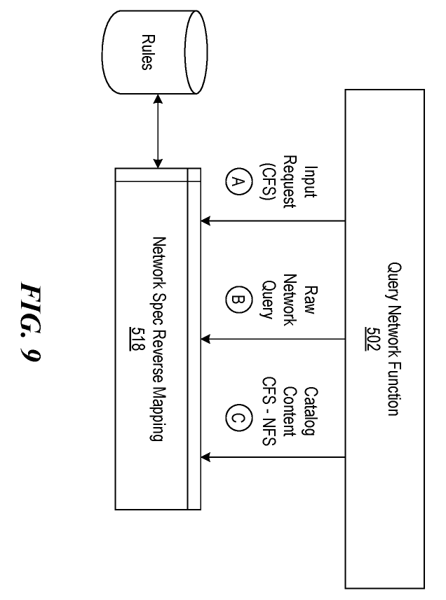

FIG. 9 depicts the network specification reverse mapping 518 performed by the query network function 502. The query network function 502 performs the network specification reverse mapping 518 to determine current or dynamic connection information for the subscriber (or particular user equipment (UE) operated by the subscriber) with the telecommunications network. To do so, the query network function 502 uses the catalog translation content as a comparison/mapping reference, and with rules, validates the raw network query. This network specification reverse mapping 518 enables detection of real-time errors that are auxiliary to service provisioning errors by identifying real-time status and parameters for each CFS assigned to the subscriber. For example, the network specification reverse mapping 518 can output active/inactive flags for certain CFSs, specific data values for some CFSs (e.g., currently active MSISDNs, registration timestamps), specific states (e.g., registered, roaming, non-registered) for other CFSs. Therefore, rather than describing whether each CFS is valid or invalid, the network specification reverse mapping 518 can inform how each CFS that is provisioned in being used in real-time. This is thus able to reveal non-provisioning errors causing service disruptions, such as the customer not receiving 5G service due to using a non-5G-enabled device or the customer’s Internet-of-Things (IoT) experiencing a service disruption due to using an incorrect access point name (APN).

Returning to FIGS. 5A-5B, the query network function 502 obtains location information for the subscriber (action 4 in FIG. 5A, actions 6-7 in FIG. 5B). Similar to the network specification reverse mapping 518, the location information provides auxiliary information that may explain causes of service disruption other than service provisioning errors. In some embodiments, the query network function 502 obtains the location information based on subscribing to and being notified from the network exposure function 514. Other traditional techniques for determining a subscriber’s location may be used, for example, via an AMF core element.

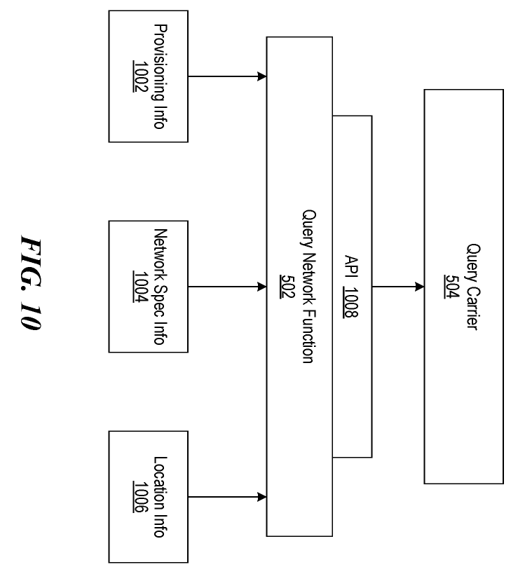

FIG. 10 depicts the query network function 502 providing a diagnosis report to the network carrier 504 (also action 5 in FIG. 5A, action 9 in FIG. 5B). In some examples, the diagnosis report includes provisioning information 1002, network specification information 1004 (or real-time connection information), and location information 1006. In some embodiments, the query network function 502 optionally includes the network specification information 1004 and/or the location information 1006 based on the network carrier 504 requesting or subscribing to those information. In some embodiments, the query network function 502 transmits the diagnosis report to the network carrier 504 via an API 1008 that may be configured as externally facing in order for the query network function 502 and some network carriers such as MVNOs to communicate.

The solutions disclosed herein enable network operators to responsively and/or preemptively solve the customer service disruption issues in a real-time manner. These solutions provide real-time information on the list of network features provisioned correctly and what is not provisioned correctly. Through automated techniques, human operators do not need detailed technical information on network elements and network profile attributes implemented at network elements to diagnose issues experienced by network customers.

Generally, while these solutions reconcile complex translations between customer-facing services and technical network configurations to identify service provisioning discrepancies, these solutions can be applied in non-telecommunication contexts as well. In particular, these solutions can be applied in environments or ecosystems in which multiple different systems manage information relevant to a common profile. In a customer profile management subsystem for an online retail platform, multiple customer profile information like purchases, credit cards, loyalty information, login and security information, notification preferences, service subscriptions, and/or the like may be individually managed by different subsystems on the platform. Technical challenges similar to those disclosed herein may arise, for example, if customer profile information is changed and the customer profile management subsystem triggers an update request with new preferences to a notification subsystem. In case the profile configurations and notifications configurations are out-of-sync, the customer may not be right notification experience. In such cases, the solutions disclosed herein may be used to detect and fix the issue immediately. For instance, the solutions can traverse a translation between profile configurations and notification configurations and perform a reverse mapping to determine whether a provisioning error exists.

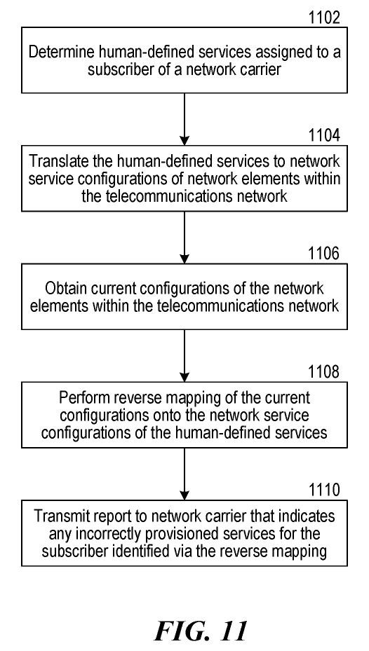

FIG. 11 illustrates a flow diagram including operations for diagnosing or auditing the provisioning of network service configurations throughout a telecommunications network used by a plurality of network carriers. The operations illustrated in FIG. 11 may be performed by a network diagnosis system, which may be implemented by a core network element (e.g., an application function) in the telecommunications network. For example, the operations are performed by the query network function illustrated and described with FIGS. 5A-5B.

At 1102, the system determines a set of human-defined services assigned to a subscriber of a network carrier. In some embodiments, the system queries a billing subsystem associated with the network carrier to retrieve the list of services (e.g., a list of CFS). The human-defined services may include various features enabled through the telecommunications network, such as voice, text, data, Wi-Fi calling, scam protection, and companion device pairing.

At 1104, the system translates the human-defined services to network service configurations of network elements within the telecommunications network. Each human-defined service may be translated to a plurality of network service configurations for a plurality of network elements across the telecommunications network. This translation is performed by transmitting a query to a network service catalog that stores translation information between the human-defined services and the network service configurations. In some embodiments, the query includes an identifier of the network carrier, based on the catalog storing translation information that is carrier-specific.

At 1106, the system obtains the current configurations of the network elements within the telecommunications network. This involves querying the network elements to retrieve their current configuration states. Additionally, the system may determine current connection information for the network elements and the user equipment (UE) associated with the subscriber, as well as the location of the UE via a network exposure function.

At 1108, the system performs a reverse mapping of the current configurations onto the network service configurations of the human-defined services. This reverse mapping identifies any discrepancies between the expected network service configurations and the actual configurations, thereby determining whether each human-defined service is correctly provisioned across the network elements. The reverse mapping process is essential for identifying incorrectly provisioned services relative to the set of human-defined services assigned to the subscriber. Through the reverse mapping, additional provisioned services that are not actually assigned to the subscriber can be identified.

At 1110, the system transmits a report to the network carrier in response to identifying one or more incorrectly provisioned services. The report indicates the incorrectly provisioned services for the subscriber, providing real-time information on the provisioning status. The report may also include auxiliary diagnosis information such as current connection information and the location of the UE. The auxiliary diagnosis information may be included based on there being a lack of incorrectly provisioned services, to provide possible alternative (and downstream) explanations for any service disruptions or interruptions being experienced by the subscriber. In some embodiments, the report is specifically transmitted to a billing subsystem associated with the network carrier. The carrier’s billing subsystem manages the billing and subscription of the human-defined services by the subscriber and therefore may handle remedial actions if the subscriber is not receiving its subscribed services and/or is receiving additional services.

In some embodiments, the system performs these operations in response to receiving a prompt from the network carrier to evaluate a service disruption experienced by the subscriber. The prompt may be received via an externally facing API accessible by the network carrier, which could be a mobile virtual network operator (MVNO). In some embodiments, the system may be configured by a network carrier to provide periodic audits of provisioned services for its subscribers. For example, the network carrier can transmit a prompt to the system that establishes a periodic frequency to provide the report.

### Example Computer Systems

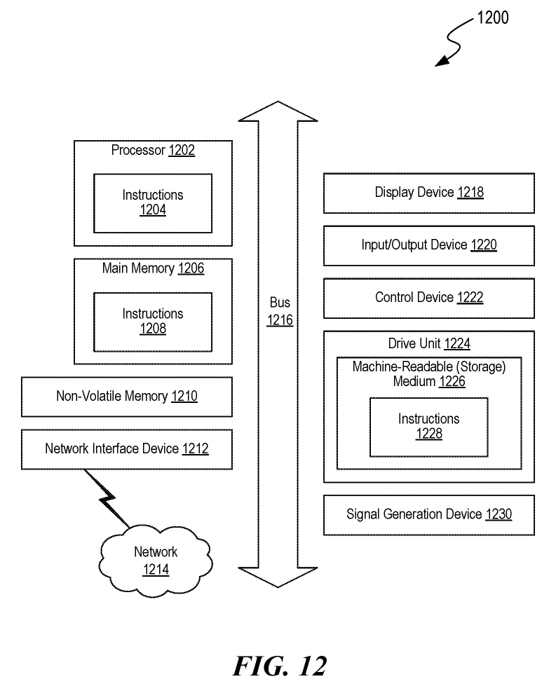

FIG. 12 is a block diagram that illustrates an example of a computer system 1200 in which at least some operations described herein can be implemented. As shown, the computer system 1200 can include: one or more processors 1202, main memory 1206, non-volatile memory 1210, a network interface device 1212, a video display device 1218, an input/output device 1220, a control device 1222 (e.g., keyboard and pointing device), a drive unit 1224 that includes a machine-readable (storage) medium 1226, and a signal generation device 1230 that are communicatively connected to a bus 1216. The bus 1216 represents one or more physical buses and/or point-to-point connections that are connected by appropriate bridges, adapters, or controllers. Various common components (e.g., cache memory) are omitted from FIG. 12 for brevity. Instead, the computer system 1200 is intended to illustrate a hardware device on which components illustrated or described relative to the examples of the figures and any other components described in this specification can be implemented.

The computer system 1200 can take any suitable physical form. For example, the computing system 1200 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1200. In some implementations, the computer system 1200 can be an embedded computer system, a system-on-chip (SOC), a single-board computer system (SBC), or a distributed system such as a mesh of computer systems, or it can include one or more cloud components in one or more networks. Where appropriate, one or more computer systems 1200 can perform operations in real time, in near real time, or in batch mode.

The network interface device 1212 enables the computing system 1200 to mediate data in a network 1214 with an entity that is external to the computing system 1200 through any communication protocol supported by the computing system 1200 and the external entity. Examples of the network interface device 1212 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1206, non-volatile memory 1210, machine-readable medium 1226) can be local, remote, or distributed. Although shown as a single medium, the machine-readable medium 1226 can include multiple media (e.g., a centralized/distributed database and/or associated caches and servers) that store one or more sets of instructions 1228. The machine-readable medium 1226 can include any medium that is capable of storing, encoding, or carrying a set of instructions for execution by the computing system 1200. The machine-readable medium 1226 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1210, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1204, 1208, 1228) set at various times in various memory and storage devices in computing device(s). When read and executed by the processor 1202, the instruction(s) cause the computing system 1200 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A network diagnosis system for a telecommunications network used by a plurality of network carriers, the network diagnosis system comprising:
at least one processor; and
at least one memory storing instructions that, when executed by the at least one processor, cause the network diagnosis system to:
receive, from a network carrier using the telecommunications network, a prompt to evaluate a service disruption experienced by a subscriber of the network carrier, the network diagnosis system being implemented at a core network of the telecommunications network;
determine a set of human-defined services that is assigned to the subscriber of the network carrier;
translate, via a query transmitted to a network service catalog, each of the set of human-defined services to a plurality of network service configurations for one or more network elements within the telecommunications network, wherein the query comprises an identifier of the network carrier in accordance with the network service catalog storing carrier-specific translation information;
obtain current configuration states of the one or more network elements;
perform a mapping between the current configuration states and the plurality of network service configurations for each of the set of human-defined services to determine whether each human-defined service is provisioned across the one or more network elements, wherein the mapping is performed to identify one or more incorrectly provisioned services relative to the set of human-defined services assigned to the subscriber; and
in response to identifying the one or more incorrectly provisioned services, transmit a report to the network carrier that indicates the one or more incorrectly provisioned services for the subscriber of the network carrier.

2. The network diagnosis system of claim 1, wherein the instructions further cause the network provisioning system to:
determine current connection information for the one or more network elements and a user equipment (UE) associated with the subscriber, the service disruption being experienced at the UE;
determine, via a network exposure function of the telecommunications network, a location of the UE; and
include the current connection information and the location as auxiliary diagnosis information in the report transmitted to the network carrier.

3. The network diagnosis system of claim 1, wherein the network carrier is a mobile virtual network operator (MVNO), and wherein the network diagnosis system receives the prompt via an externally facing API accessible by the MVNO.

4. The network diagnosis system of claim 1, wherein the prompt further specifies a periodic audit of audit of provisioned services for a set of other subscribers of the network carrier, and wherein the instructions further cause the network diagnosis system to periodically transmit subsequent reports to the network carrier according to the prompt.

5. The network diagnosis system of claim 1, wherein the one or more incorrectly provisioned services includes a human-defined service that is provisioned in the telecommunications network for the subscriber but that is not included in the set of human-defined services assigned to the subscriber.

6. The network diagnosis system of claim 1, wherein the set of human-defined services is determined by querying a billing subsystem associated with the network carrier.

7. A method for auditing services provisioned within a telecommunications network used by a plurality of network carriers, the method comprising:
determining a set of human-defined services that is assigned to a subscriber of a network carrier using the telecommunications network;
translating each of the set of human-defined services to a plurality of network service configurations for one or more network elements within the telecommunications network;
performing a reverse mapping of current configuration states of the one or more network elements onto the plurality of network service configurations of each of the set of human-defined services, the reverse mapping identifying one or more incorrectly provisioned services relative to the set of human-defined services assigned to the subscriber; and
in response to identifying the one or more incorrectly provisioned services, transmitting a report to the network carrier that indicates the one or more incorrectly provisioned services for the subscriber of the network carrier.

8. The method of claim 7, wherein each of the set of human-defined services is translated based on transmitting a query to a network service catalog that stores translation information between the human-defined services and the network service configurations.

9. The method of claim 8, wherein the query comprises an identifier of the network carrier in accordance with the translation information being carrier-specific.

10. The method of claim 7, further comprising:
receiving, from the network carrier using the telecommunications network, a prompt to evaluate a service disruption experienced by the subscriber of the network carrier, wherein the report is transmitted to the network carrier in response to the prompt.

11. The method of claim 7, wherein the report is transmitted to the network carrier according to a periodic subscription by the network carrier to the auditing of services provisioned within the telecommunications network.

12. The method of claim 7, further comprising:
determining current connection information for the one or more network elements and a user equipment (UE) associated with the subscriber of the network carrier;
determining, via a network exposure function of the telecommunications network, a location of the UE; and
including the current connection information and the location in the report transmitted to the network carrier.

13. The method of claim 7, wherein the network carrier is a mobile virtual network operator (MVNO), and wherein the report is transmitted to the network carrier via an externally facing API associated with the telecommunications network accessible by the MVNO.

14. The method of claim 7, wherein the one or more incorrectly provisioned services includes a particular human-defined service that is provisioned in the telecommunications network but that is not included in the set of human-defined services assigned to the subscriber.

15. The method of claim 7, wherein the set of human-defined services assigned to the subscriber is determined by querying a billing subsystem associated with the network carrier.

16. The method of claim 7, wherein the report is transmitted to a billing subsystem associated with the network carrier.

17. A non-transitory computer-readable storage medium storing instructions that, when executed by at least one processor of a system, cause the system to implement operations comprising:
determining a set of human-defined services that is assigned to a subscriber of a network carrier using a telecommunications network;
translating each of the set of human-defined services to a plurality of network service configurations for one or more network elements within the telecommunications network;
performing a reverse mapping of current configuration states of the one or more network elements onto the plurality of network service configurations of each of the set of human-defined services, the reverse mapping identifying one or more incorrectly provisioned services relative to the set of human-defined services assigned to the subscriber; and
in response to identifying the one or more incorrectly provisioned services, transmitting a report to the network carrier that indicates the one or more incorrectly provisioned services for the subscriber of the network carrier.

18. The non-transitory computer-readable storage medium of claim 17, wherein each of the set of human-defined services is translated based on transmitting a query to a network service catalog that stores translation information between the human-defined services and the network service configurations.

19. The non-transitory computer-readable storage medium of claim 17, wherein the operations further comprise:
receiving, from a network carrier using the telecommunications network, a prompt to evaluate a service disruption experienced by a subscriber of the network carrier, wherein the report is transmitted to the network carrier in response to the prompt.

20. The non-transitory computer-readable storage medium of claim 17, wherein the operations further comprise:
determining current connection information for the one or more network elements and a user equipment (UE) associated with the subscriber of the network carrier;
determining, via a network exposure function of the telecommunications network, a location of the UE; and
including the current connection information and the location in the report transmitted to the network carrier.
